(19) United States
(12) Patent Application Publication
(10) Pub. No.: US 2002/0169643 A1
(43) Pub. Date: Nov. 14, 2002

(54) System and method for remotely processing reservations

(75) Inventors: Thomas D. Petite, Douglasville, GA (US); James Davis, Woodstock, GA (US)

Correspondence Address: Daniel R. McClure, THOMAS, KAYDEN, HORSTEMEYER, & RISLEY, L.L.P., 100 Galleria Parkway, N.W., Suite 1750, Atlanta, GA, 30339-5948, US

(73) Assignee: StatSignal Systems, Inc., Atlanta, GA

(21) Appl. No.: 09/853,216

(22) Filed: May 11, 2001

(51) Int. Cl. G06F 17/60

(52) U.S. Cl. 705/5

(57) ABSTRACT

A system and method for remotely processing reservations. In accordance with one aspect of the invention, the system includes a reservation processing unit, and a receiver provided at the reservation processing unit for receiving data transmitted via a electromagnetic waves. The system of the invention includes a remote access unit having a memory configured to store customer identification information and a low-power transmitter adapted to transmit the customer identification information to the receiver. The remote access unit is manually operated by a transmit button, which, when depressed, causes a controller to retrieve customer identification information from the memory and transmit the customer identification information from the low-power transmitter.

### FIELD OF THE INVENTION

The present invention generally relates to processing clients that visit a business location. More specifically, the invention relates to an apparatus and a method for remotely identifying when a business client has generally arrived at the business location.

### BACKGROUND OF THE INVENTION

As is known, there are a variety of systems and methods for monitoring and processing reservations. While many enterprises process reservations manually, i.e., by keeping handwritten lists, there has been a trend in utilizing automated systems in the form of computers and display interfaces with associated data input devices to provide a more efficient and less error prone means of processing the reservations.

The automated systems presently being used offer certain advantages over manually processed reservations. For example, rather than manually maintaining hardcopy lists of names with erasures and crossouts, automated systems generally provide an easily read list on an output device such as a display. Reservations and real time information, such as, cancellations may be tracked simply by deleting or adding information as required. Lists are therefore neat and easily read. As well, these systems often provide other features such as displays of floor plans, as in a dining facility, that indicate available seating and which parties are to be located at which tables.

Although the automated systems currently in use provide a number of advantages over the traditional method of manually recording reservations, both methods share a common problem. If the party having made the reservation is not physically present at the time of the reservation, the person maintaining the list is posed with the problem of either filling the apparent vacancy in order to maximize revenue or holding the spot open in hopes the concerned party will eventually arrive or contact the establishment with updated estimated time of arrival. As a result, when a party is late for a reservation, their table or appointment may be offered to someone else that either has not made a reservation, or is merely scheduled for a later time. Subsequently, the concerned party either loses their reservation, is forced to wait for a later time slot, or the person processing the reservation list is forced to juggle the list to accommodate the changed situation. This scenario may arise even though the party in question is in close proximity to the establishment but they have been delayed. For example, the party could be looking for parking. Prior systems provide no means to directly inform an establishment that a party with a reservation or appointment is near the premises and intends to keep the reservation.

More significantly, using current reservations systems, customers having reservations at restaurant establishments often arrive only to be required to wait for their table to be “prepared.”

Accordingly, an alternative solution for processing reservations that overcomes the shortcomings of the prior art is desired.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve the advantages and novel features, the present invention is generally directed to an improved system and method for processing reservations, particularly in restaurant establishments. However, the use of the present invention in any establishment utilizing reservations, is envisioned. As well, the present invention can be used to establish the use of reservations in various environments where their use has not been feasible in the past. Broadly, the invention allows a customer (having a reservation) to notify the restaurant establishment of his or her arrival by pressing a transmit button on a low-power RF transmitter. This transmission is received by the restaurant establishment shortly before the customer's arrival (e.g., when the customer reaches the parking lot), to allow the restaurant time to ready the customer's reserved table, so there is no wait when the customer walks in the door.

In one embodiment, the system includes a reservation processing unit, and receiving means provided at the reservation processing unit for receiving data transmitted via electromagnetic waves. The system of the invention further includes a remote access unit having a memory configured to store customer identification information and a low-power transmitter adapted to transmit the customer identification information to the receiving means. The remote access unit is manually operated by a transmit button, which, when depressed, causes a controller to retrieve customer identification information from the memory and transmit the customer identification information from the low-power transmitter.

In accordance with an alternative embodiment, a similar system could be used even for patrons/customers without reservations. In this embodiment, the reservation processing unit would maintain a data base containing customer identification information of previous customers and other potential customers who request to be included in the data base. This embodiment allows a customer (without a reservation) to notify the restaurant establishment of his or her arrival by pressing a transmit button on a low power RF transmitter. This transmission is received by the restaurant establishment, and if the customer identification information in the transmission corresponds to customer identification in the data base, and assuming there are open reservations, a reservation will be made for the customer.

In accordance with an alternative embodiment, the reservation processing unit includes a network link that provides internet access, thereby allowing customers to make their own reservations with the reservation processing unit. A customer (without a reservation) can be provided with information regarding the availability of reservations by the reservation processing unit and use this information to secure the desired reservation. After the reservation has been made, the system functions as noted above to allow the customer to notify the restaurant establishment of their arrival.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a schematic, illustrating the functionality of the present invention;

FIGS. 2A and 2B are schematics, illustrating the principal components of a system constructed in accordance with the present invention;

FIG. 3 is a functional block illustrating a transmitter and reservation processing unit constructed in accordance with a preferred embodiment of the present invention; and

FIG. 4 is a flowchart illustrating a method for providing status information to a remotely located receiver in accordance with a preferred embodiment of the present invention.

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

### DETAILED DESCRIPTION OF THE PREFERRED EMBODIMENT

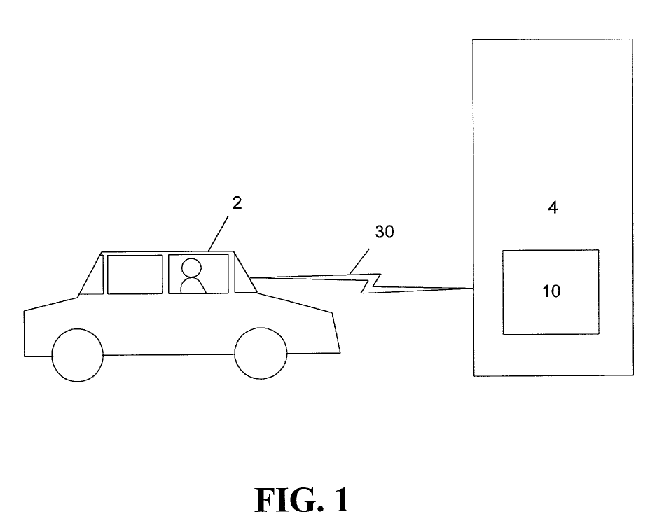

Turning now to the drawings, FIG. 1 shows a schematic representation of the functionality of the present invention. As shown, a customer 2 is notifying a restaurant establishment 4 of his pending arrival while the customer 2 is still in the parking lot. This is accomplished by sending an electromagnetic signal 30 to the reservation processing unit 10, located on the premises of the restaurant establishment 4.

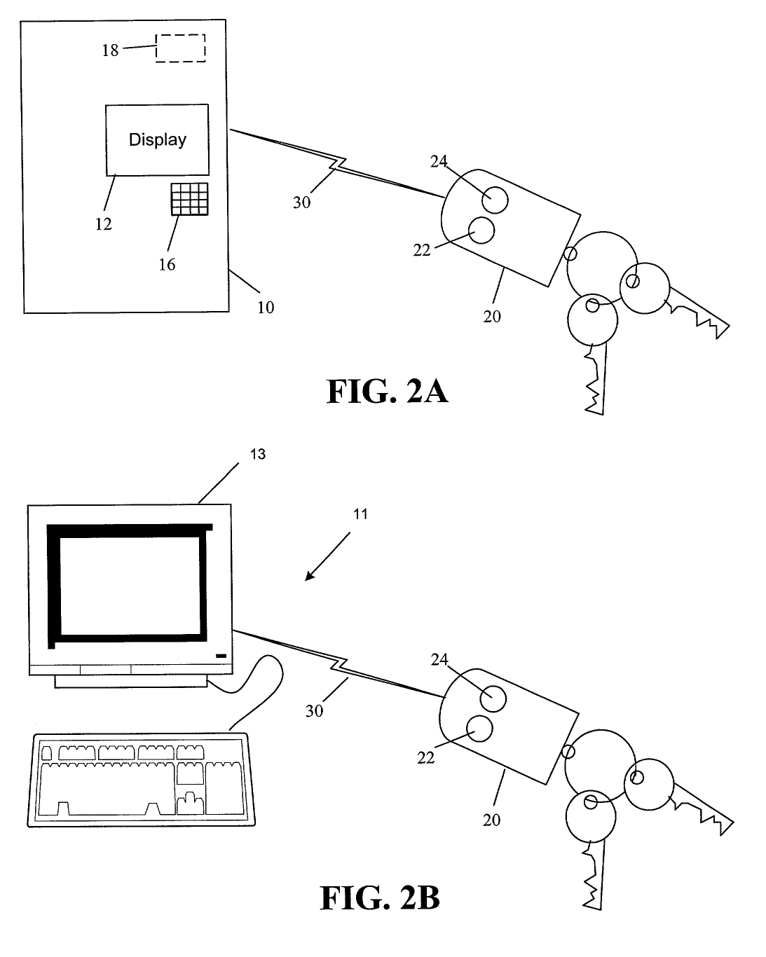

FIG. 2A shows a schematic of a reservation processing unit 10 constructed in accordance with the teachings of the present invention. More specifically, the figure shows a reservation processing unit 10 being remotely accessed by a transmitter 20. The reservation processing unit 10 may be any of a number of devices, including, most commonly, a personal computer 11 and monitor 13 (FIG. 2B). However, the reservation processing unit 10 may further encompass devices such as registers equipped to display reservation information. It will be appreciated that other similar devices fall within the scope of the present invention. Hereinafter, unless specifically noted otherwise, general reference to the reservation processing unit 10, will be understood to encompass the various types of equipment, including personal computers, that are contemplated by and encompassed within the teachings of the present invention.

For example, FIG. 2B shows a similar diagram that specifically illustrates the present invention, as embodied in a personal computer 11. Although not shown if FIG. 2B, a receiver (discussed below) is commuicatively coupled with the personal computer 11 (possibly internal) that receives electromagnetic signals 30 for access to the personal computer 11. This receiver forms an integral part of the present invention, and will be further discussed below.

In the embodiment illustrated in FIG. 2A, the reservation processing unit 10 includes a display 12, such as a CRT or LED, for providing a visual display to a user. A key pad 16 for inputting information, such as a party's name when a reservation is first made, is also illustrated in the drawing.

Finally, the last functional block illustrated in the reservation processing unit 10 of FIG. 2A is receiving unit 18. The receiving unit 18 has been illustrated in dashed lines, since it will typically reside inside the reservation processing unit 10. The receiving unit 18 is adapted to receive a signal transmitted from a remote transmitter 20, interpreting that signal in order to update the information displayed to the user of the reservation processing unit 10. Preferably, the receiving unit 18 comprises a radio frequency (RF) receiver for receiving electromagnetic waves transmitted from an RF transmitter contained with the remote transmitter unit 20. However, consistent with the concepts and teachings in the present invention, the receiving block 18 may be configured to receive other wavelength electromagnetic signals, including ultrasonic or infrared.

A remote transmitting unit 20 is provided for remote communications with the reservation processing unit 10. While the transmitter 20 will be described in more detail below, it broadly operates to transmit an electromagnetic signal 30 to a receiver commuicatively coupled with the reservation processing unit 10, wherein said electromagnetic signal 30 is encoded with customer identifying information to allow for display of appropriate information on the reservation processing unit's 10 display 16. In this regard, an internal transmission circuit (not shown) is provided within the transmitter 20 to act upon command to transmit the encoded electromagnetic signal 30. A transmit button 22 is provided for the customer. As illustrated in the preferred embodiment, the transmitter 20 is quite small and may be conveniently attached, for example, to a key ring for ready and portable use. Indeed, in one embodiment, the single transmitter constructed in accordance with the present invention may serve multiple functions. For example, small transmitters of this type are known for activating and deactivating automobile alarm systems, and the like. The transmitter 20 of the present invention may be integrally designed with such an automobile remote to provide the dual functionality of remotely controlling an automobile alarm along with the functionality of disseminating information to a remote reservation processing unit 10. In accordance with such an embodiment, a second transmit button 24 would be provided. In this regard, the first transmit button 22 would be operative to, for example, operate the reservation processing unit 10, while the second transmit button 24 would be operative to remotely operate an automobile alarm. It will be appreciated that the frequency, and/or format of the electromagnetic signal 30 transmitted may be different for the different applications. For example, the signal transmitted to the reservation processing unit 10 will include personal identification information, while only a unique activation sequence need be transmitted to actuate an automobile alarm.

In use, a customer would simply depress a transmit button 22, which would result in the transmitter 20 transmitting an electromagnetic signal 30 to a remote reservation processing unit 10. Preferably, the transmitter 20 is a low power transmitter, so that a customer will have to be in close proximity, (e.g., several hundred feet) to the receiver 18 of a reservation processing unit 10 in order to use the transmitter. This would help alleviate problems which may otherwise occur if a customer approaches an area where there are multiple establishments with receivers present. This low-power operation helps to prevent the unlawful interception of the electromagnetic signals. In addition, in an alternative embodiment of the invention, the transmitted signal may be encrypted for further protection against such unlawful interception.

A receiving unit 18 within the reservation processing unit 10 receives and decodes the signal 30. The reservation processing unit 10 then posts the received, decoded customer identification portion of the signal on a display 12. The user viewing the information on the display 12 may then use this information to update reservation information or the update may occur automatically. The reservation processing unit 10 then evaluates the received, decoded signal to ensure that it identifies a legitimate customer/account. If so, the customer may then access the account for whatever purchases are conducted. For example, the customer would not have to provide a credit card for billing, as any purchases would already be charged to the account corresponding to the signal previously sent by the customer.

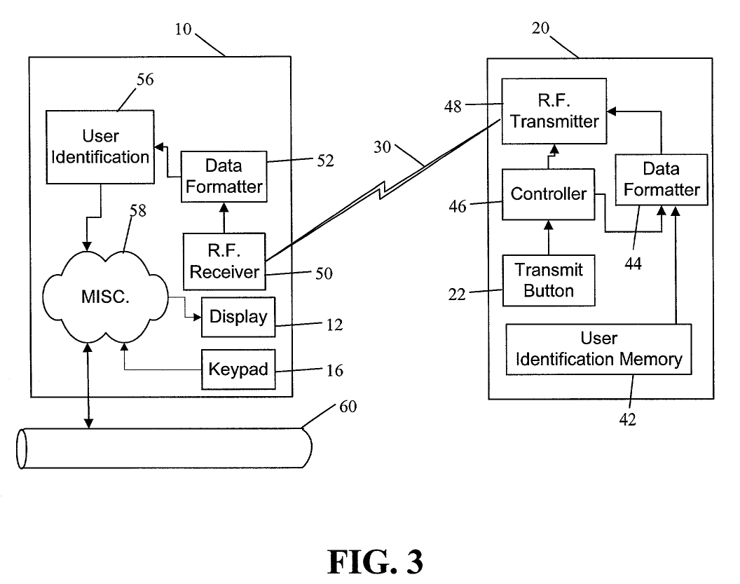

As previously noted, the reservation processing unit 10 has applications other than those establishments that traditionally receive reservations, such as restaurant establishments 4 (FIG. 1). For example, the reservation processing unit 10 can be used to better control operations such as parking (e.g., airport parking). In use, a customer may make a reservation in advance, either by contacting the establishment or through the Internet via a network link 60 (FIG. 3). Upon arrival at a parking establishment, a customer simply initiates data transmission by depressing the transmit button 22. As discussed above, after the reservation processing unit 10 evaluates the received, decoded signal to ensure that it identifies a legitimate customer/account, the customer is allowed to enter the parking lot. Note, as with the restaurant establishment 4 (FIG. 1), the reservation processing unit 10 does not necessarily require a prior reservation. For example, a customer may have his customer identification information in a database to which the reservation processing unit 10 has access. When the customer arrives and presses the transmit button 22, if the customer identification information in the electromagnetic signal 30 corresponds to customer identification information in the database, and assuming that there are open spaces in the parking lot, the customer will be granted access.

Upon leaving the parking lot, the customer may simply depress the transmit button 22 again, thereby transmitting the customer identification information to the reservation processing unit 10 and allowing an automated parking lot attendant (e.g., computer) to determine the duration of time that the customer's vehicle occupied the parking lot. After the reservation processing unit 10 evaluates the signal to identify a legitimate customer/account, the customer may either pay in the traditional fashion or choose to have the charges automatically billed to an account associated with the customer's transmitter code. Although one may desire to have an attendant present to visually verify identification of the customer prior to exiting the lot, it is believed the reservation processing unit 10 provides the potential for a completely automated parking system where access is granted, charges are computed and billed, and egress may be allowed solely through the reservation processing unit 10.

Having now presented an overview of the basic operation of the present invention, reference is made to FIG. 3, which shows a more detailed block diagram of the components contained within the reservation processing unit 10 and remote transmitting unit 20. As previously mentioned, the transmitting unit 20 includes a transmit button 22, which initiates the data transmission. The other primary functional blocks of the transmitter 20 include a memory 42, a data formatter 44, a controller 46, and an RF transmitter 48. It will be appreciated that the functional blocks shown in FIG. 3 are shown for purposes of illustration and facilitating a better understanding of the broad concepts of the present invention. The functional blocks of the illustrated embodiment should not, however, be viewed as specific limitations on the invention. For example, data formatter 44 and controller 46 (discussed below) may be embodied in a single functional unit. Indeed, it is contemplated that the entirety of the circuitry of the transmitter 20 will be contained within a single integrated circuit component.

In keeping with the description of the transmitter 20, the controller 46 lies at the heart of the transmitter 20, and serves to control the overall functionality thereof. In this regard, the controller 46 is responsive to the depression or actuation of transmit button 22 to begin the data transaction and signal transfer. More particularly, when a customer depresses the transmit button 22, the controller 46 initiates the data transmission sequence by accessing an internal memory 42, which, among other things, stores customer identification information. This information is then passed to a data formatter 44, which places the data in an appropriate and predefined format for transmission to the reservation processing unit 10. It is contemplated that the above-described functionality occurs in electronic format.

This electronic data is then sent from data formatter 44 to an RF transmitter 48 where it is encoded using one or more sine waves and forwarded to an antenna (not shown) which radiates the data signal in the form of electromagnetic energy. As is well known by those skilled in the art, a variety of transducers can perform this functionality adequately.

The reservation processing unit 10 receives the transmitted electromagnetic signal 30 at an RF receiver 50. This RF receiver 50 serves to convert the data from electromagnetic format into electrical format (i.e., a digital signal) and passes that data to a data formatter 52. Also illustrated as comprising principal functional components of the reservation processing unit 10 are the display 12, a keyboard 16, a block denoted as User Identification 56, a cloud denoted as miscellaneous 58, and a network link 60. The network link 60 can be used by the reservation processing unit 10 to access data banks stored remotely from the reservation processing unit 10. As well, the network link 60 can be used by customers to gain internet access to the reservation processing unit 10 and thereby make their own reservations.

In keeping with the description of the reservation processing unit 10, the information received and formatted by the data formatter 52 is then transmitted to a block denoted as User Identification 56. This functional block serves to verify that the customer identification information received by the RF receiver 50 is valid. To do this, the reservation processing unit 10 may access a centralized database (not shown) via a network link 60, or may maintain a database on site. It will be appreciated that this account verification functionality is well known in the prior art, and therefore, need not be discussed herein.

Finally, a block 58 denoted as “Misc.” is illustrated within the reservation processing unit 110. This functional block 58 performs a variety of functional features which depend, in part, upon the specifics of the reservation processing unit 10. For example, the block will manage user input and output to and from the display 12 and keypad 16, as well as network 60 management and access. It would further serve to access any database of information that is i s stored locally at the reservation processing unit 10. This block 58 has been denoted broadly herein as “Misc.” because it deals with features and functionality of reservation processing units 10 which are not pertinent to an understanding of the present invention, and need not be discussed herein.

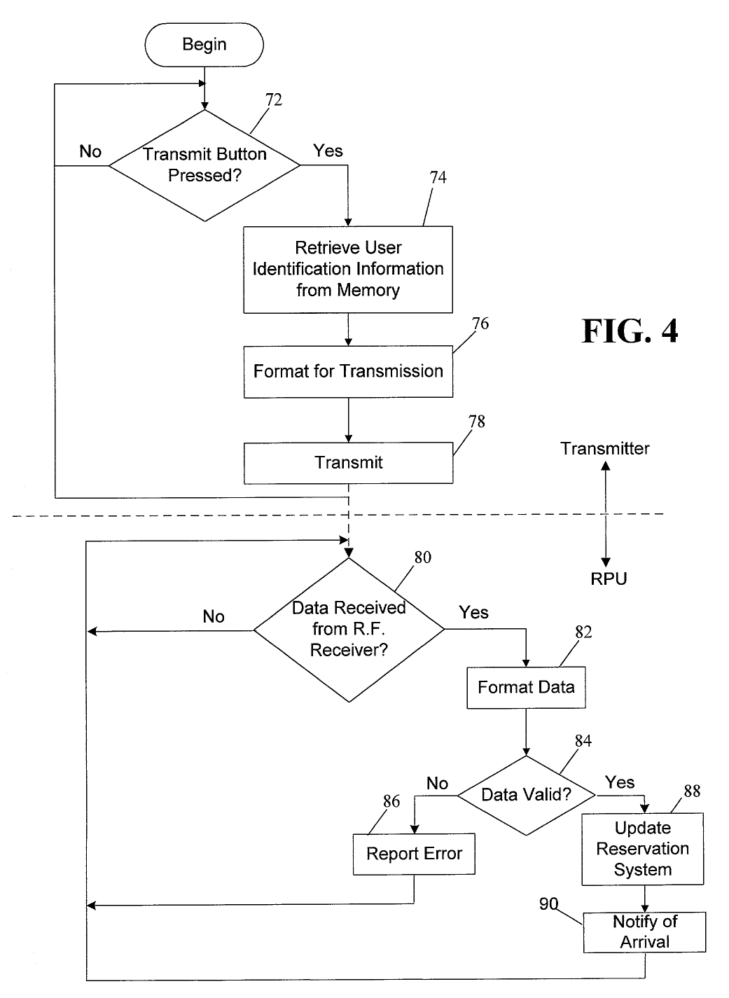

Having described the relevant functional aspects and components of the reservation 20 processing unit 10 and transmitting unit 20, reference is now made to FIG. 4, which is a flow chart illustrating the principal operation of a system constructed in accordance with the teachings of the present invention. For clarity, a dashed horizontal line has been drawn near the center of FIG. 4. The functionality denoted in the blocks above the dashed line reflect functions and features which take place within the transmitter unit 20. The blocks depicted below the horizontal line reflect functions and features that take place within the reservation processing unit 10. It is contemplated that each unit of the system will separately operate in a repeating and continuous loop, and the flowchart of FIG. 4 is provided merely for illustration. Upon power-up (denoted as the BEGIN state), the transmitter 20 begins to monitor the transmit button 22 (step 72). For simplicity and illustration, the flow chart of FIG. 4 assumes that the transmitter 20 has only a single transmit button 22. However, as has been previously described, alternative embodiments of the present invention may embody multiple transmit buttons. In these situations, the functional block denoted as step 72 would recognize the depression of any one of the transmit buttons, identify the particular button depressed, and take the appropriate and corresponding actions. Once the transmit button is depressed and the condition denoted in step 72 resolves to the true state, the transmitter unit 20 then operates to retrieve the customer identification information from a memory unit stored on the transmitter 20 (step 74). Thereafter, the customer identification information is sent to formatter which formats the data for transmission in accordance with the data transmission protocol. A message protocol that is operative for a preferred embodiment of the present invention is described in detail in U.S. patent application having Ser. No. 09/812,044, and entitled “System and Method for Monitoring and Controlling Remote Devices,” the contents of which are incorporated herein by reference. Finally, the transmitter 20 sends the data from the data formatter 44 (FIG. 3) to an RF transmitter 48 (FIG. 3), and transmits the data via electromagnetic waves (step 78). After executing step 78, the functional loop of the transmitter unit 20 will proceed back up to the beginning step, and once again, begin monitoring the transmit button at step 72.

As represented by dashed lines, data is transmitted to a RF receiver 50 (FIG. 3) which is contained at the reservation processing unit 10. Like the transmitter 20, the functionality of the reservation processing unit 10 repeats continuously in an infinite loop. As a first step, the data transmitted via electromagnetic waves is received by the RF receiver 50 (FIG. 3) (step 80). If the receiver does not recognize the data received, then step 80 resolves to false and the system returns to monitoring for other electromagnetic waves. If the RF receiver 50 (FIG. 3) recognizes data transmitted from the RF transmitter 48 (FIG. 3), then the system proceeds to step 82 where the data is formatted. Thereafter, and in a manner generally known, the system will check to see if the data received was valid (step 84), and if not, the system may report an error at step 86 and return to the beginning step. Alternatively, if the data received from the RF receiver 50 (FIG. 3) is determined to be valid, step 84 resolves to true, then the system will update the reservation system (step 88). Thereafter, the reservation system will proceed to notify ther restaurant establishment of the customer's pending arrival (step 90).

The foregoing description has been presented for purposes of illustration and description. It is not intended to be exhaustive or to limit the invention to the precise forms disclosed. Obvious modifications or variations are possible in light of the above teachings. The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A system for processing reservations, comprising:
a reservation processing unit configured to track and process customer reservation;
receiving means for receiving data transmitted via a electromagnetic waves, the receiving means being operatively disposed with the reservation processing unit; and
a remote access unit having a memory configured to store customer identification information and a low-power transmitter adapted to transmit the customer identification information to the receiving means, the remote access unit further having a manually-operated transmit button and a controller, responsive to the transmit button, to controllably retrieve customer identification information from the memory and transmit the customer identification information from the low-power transmitter.

2. The system as defined in claim 1, wherein the receiving means receives electromagnetic data in a wavelength selected from the group consisting of:
radio frequency;
ultrasonic; and
infra-red.

3. The system as defined in claim 1, wherein electronic circuitry that carries out the functionality of the remote access unit is contained within a single integrated circuit.

4. The system as defined in claim 1, wherein the remote access unit includes means for formatting the customer identification information into a data packet for transmission to the receiving means.

5. The system as defined in claim 1, wherein the remote access unit further includes a second transmit button.

6. The system as defined in claim 1, wherein the reservation processing unit further includes a network link configured to provide internet access.

7. A method for processing reservations comprising the steps of:
receiving a transmitted electromagnetic signal including customer identification information at a receiver;
retrieving the customer identification information from the transmitted electromagnetic signal;
updating reservation information using the customer identification information; and
providing a notification that the customer is about to arrive.

8. The method as claimed in claim 7, further comprising the step of receiving a reservation over an internet connection.

9. The method as claimed in claim 7, further comprising the step of displaying the updated reservation information.

10. The method as claimed in claim 7, wherein the step of receiving a transmitted electromagnetic signal further comprises receiving a low-power radio frequency signal.

11. The method as claimed in claim 7, wherein the transmitted electromagnetic signal is generated by depressing a manually-operative transmit button of a remote access unit.

12. The method as claimed in claim 11, wherein the customer identification information is retrieved from an internal memory of the remote access unit.

13. The method as claimed in claim 12, wherein the retrieved customer identification information is formatted into a predefined signal prior to transmission.

14. A system for remotely processing reservations, comprising:
a reservation processing unit, configured to receive customer identification information from a remote access unit having a memory configured to store customer identification information and a low-power transmitter adapted to transmit the customer identification information, the remote access unit further having a manually-operated transmit button and a controller responsive to the transmit button to controllably retrieve customer identification information from the memory and transmit the customer identification information from the low-power transmitter; and
receiving means associated with the reservation processing unit for receiving data transmitted via a electromagnetic waves.

15. A computer readable storage medium containing program code for controlling the operation of a system for providing remote processing of reservations, the system comprising:
a reservation processing unit;
receiving means for receiving data transmitted via a electromagnetic waves; and
a remote access unit having a memory configured to store customer identification information and a low-power transmitter adapted to transmit the customer identification information to the receiving means, the remote access unit further having a manually-operated transmit button and a controller, responsive to the transmit button, to controllably retrieve customer identification information from the memory and transmit the customer identification information from the low-power transmitter.
